(19) United States
(12) Patent Application Publication
(10) Pub. No.: US 2004/0117337 A1
(43) Pub. Date: Jun. 17, 2004

(54) Export compliance system and method

(76) Inventors: Walter R. Beck, Redmond, WA (US); Charles E. Coleman, Lakewood, WA (US); Douglas K. Julen, Redmond, WA (US)

Correspondence Address: BLACK LOWE & GRAHAM, PLLC, 701 FIFTH AVENUE, SUITE 4800, SEATTLE, WA, 98104, US

(21) Appl. No.: 10/317,541

(22) Filed: Dec. 11, 2002

(51) Int. Cl. G06F 7/00

(52) U.S. Cl. 707/1

(57) ABSTRACT

A system and computer-based method are provided for performing export compliance review of electronic documents. An electronic document is submitted for export compliance review to a server over a network. The server automatically reviews the submitted document according to predefined export compliance rules and automatically generates export compliance information based on the review. Final export compliance information for the submitted document is generated based on an export compliance officer's review of the automatically generated export compliance information with respect to the export compliance rules. The final export compliance information is stored with the submitted document.

### FIELD OF THE INVENTION

This invention relates generally to document processing and, more specifically, to export compliance checking of documents.

### BACKGROUND OF THE INVENTION

The U.S. Government and other governments maintain a number of regulations that inform companies about the content in documents that can and cannot be exported to foreign countries, and/or foreign nationals. Communication of information to a foreign national, even in visual or oral form, constitutes an export. Examples of these regulations in the U.S. are the Export Administration Regulations (EAR) (administered by the Department of Commerce) and the International Traffic in Arms Regulations (ITAR) (administered by the State Department). In order to comply with these government regulations, an organization must perform a detailed review of every document that is to be exported or sent to employees who may be foreign nationals or to entities outside the U.S.

In large companies, hard copies or electronic copies of documents may be sent to various components of the company or to other companies in other countries. Compliance with these regulations requires a person licensed by the agencies that maintain the regulations to perform a read-through and analysis of the document with respect to all the pending regulations. This is a daunting process. As a result, not all exports may be identified and appropriately licensed in advance of the export. Therefore, many companies are assessed fines for failure to comply with the regulations. Often times these fines result simply because there does not exist an easy system for enabling all employees to make sure that documents are first cleared by regulators before delivery, and because there may not be enough regulators to review all the documents requiring review.

Therefore, there exists a need for providing an export compliance program that can enable an organization that exports information to more readily adhere to export regulations.

### SUMMARY OF THE INVENTION

The present invention provides a system and a computer-based method for performing export compliance review of electronic documents. One embodiment of the method includes submitting an electronic document for export compliance review to a server over a network. The server automatically reviews the submitted document according to predefined export compliance rules and automatically generates export compliance information based on the review.

Final export compliance information for the submitted document is generated based on an export compliance officer's review of the automatically generated export compliance information with respect to the export compliance rules. The final export compliance information is stored with the submitted document.

### BRIEF DESCRIPTION OF THE DRAWINGS

The preferred and alternative embodiments of the present invention are described in detail below with reference to the following drawings.

FIG. 1 is a block diagram of an exemplary system formed in accordance with the present invention;

FIG. 2 is a process performed by the system shown in FIG. 1 for performing document export compliance in accordance with the present invention;

FIG. 3 is an example process performed by the system of FIG. 1 for allowing a user to search a database for resources based on accessibility requirements;

FIGS. 4-6 illustrate exemplary graphical user interface windows used in the process shown in FIG. 2; and

FIGS. 7-9 illustrate exemplary graphical user interfaces for allowing a user to perform the process shown in FIG. 3.

### DETAILED DESCRIPTION OF THE INVENTION

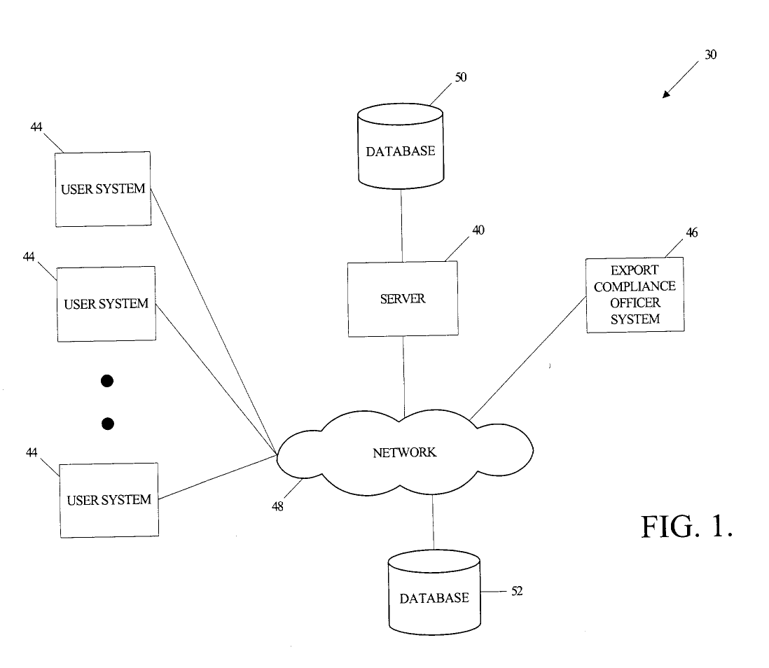

FIG. 1 illustrates an example system 30 that allows an organization to more efficiently and effectively check electronic documents in relation to export compliance regulations and to perform searches of reviewed documents and other associated resources in an organization's database. The system 30 includes a server 40 coupled to a plurality of user systems 44 and one or more export compliance officer systems 46 over a network 48. The server 40 is also directly coupled to a database 50 or is connected to a database 52 over the network 48. The network 48 is suitably a public or private data network. The user systems 44, the server 40, and the export compliance officer system 46 are suitably general-purpose computers with off-the-shelf components and software except for an export compliance application program and search engine described below.

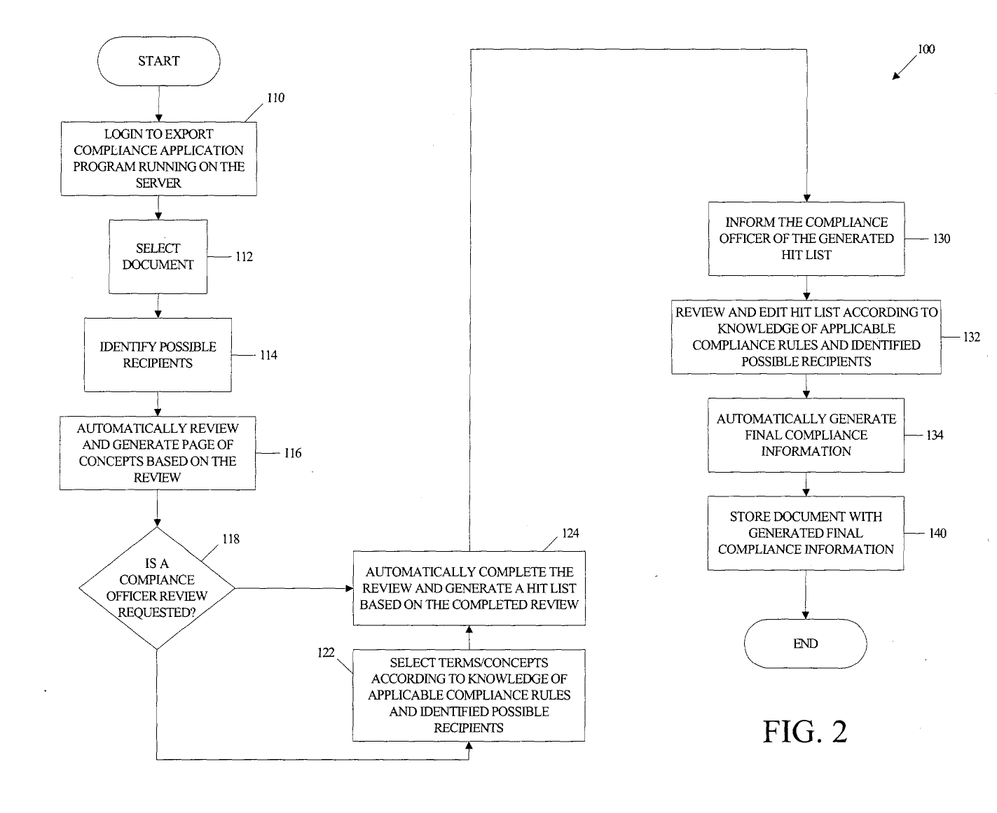

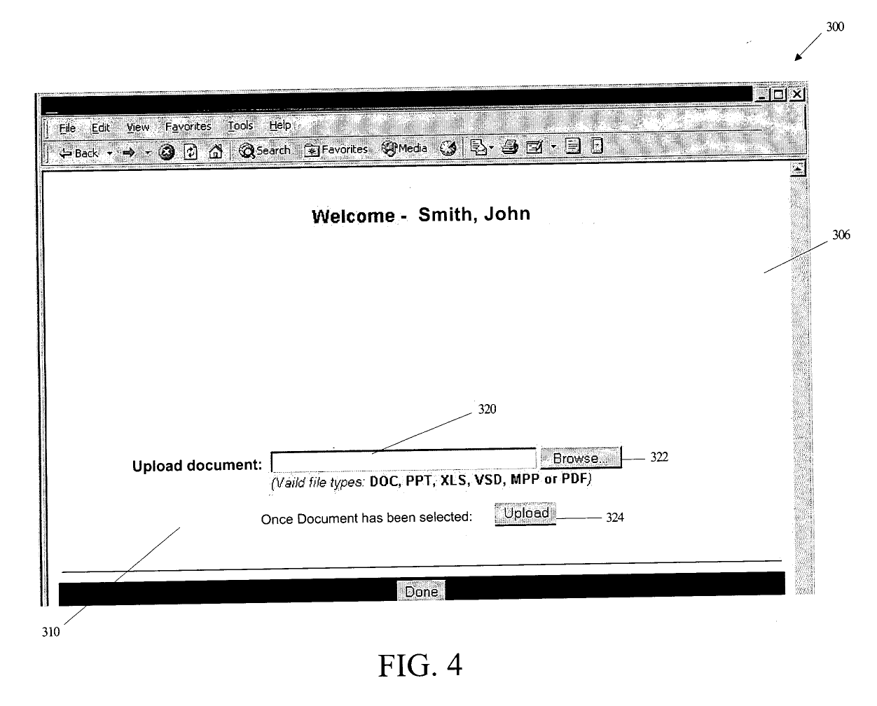

The server executes an export compliance application program. Users using user systems 44 access the server 40 and the export compliance application program over the network 48. The users submit documents from a memory device that is associated with their user system 44 or from an associated database connected to the network, such as the database 52. The export compliance application program reviews the submitted documents according to all pending export compliance regulations or any other regulations. The results of the document review are reviewed by an export compliance officer using the export compliance officer system 46 coupled to the network 48. The export compliance officer generates the final export compliance information by reviewing the document and the results of the export compliance application program, and edits as necessary the results of the export compliance application program. The final export compliance information is stored in the database 50 or other accessible databases with the associated document. The document export compliance process is shown in more detail below in FIG. 2 and by way of non-limiting example in FIGS. 4-6.

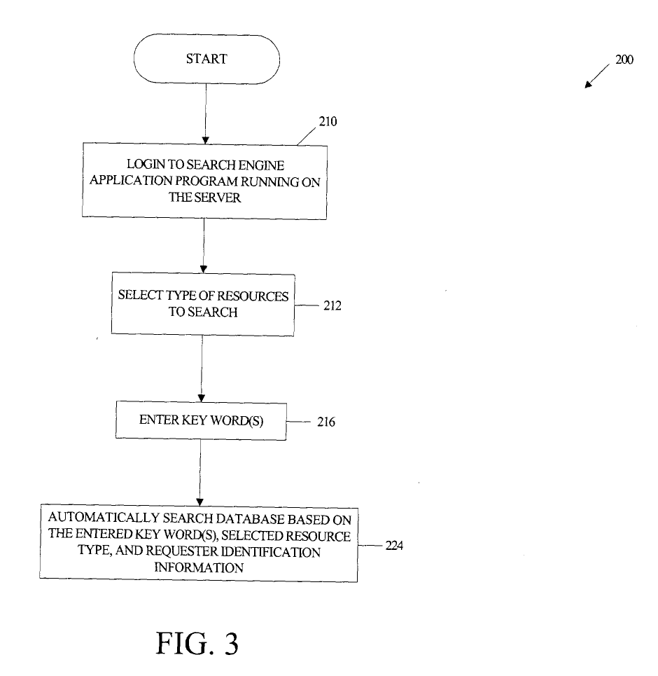

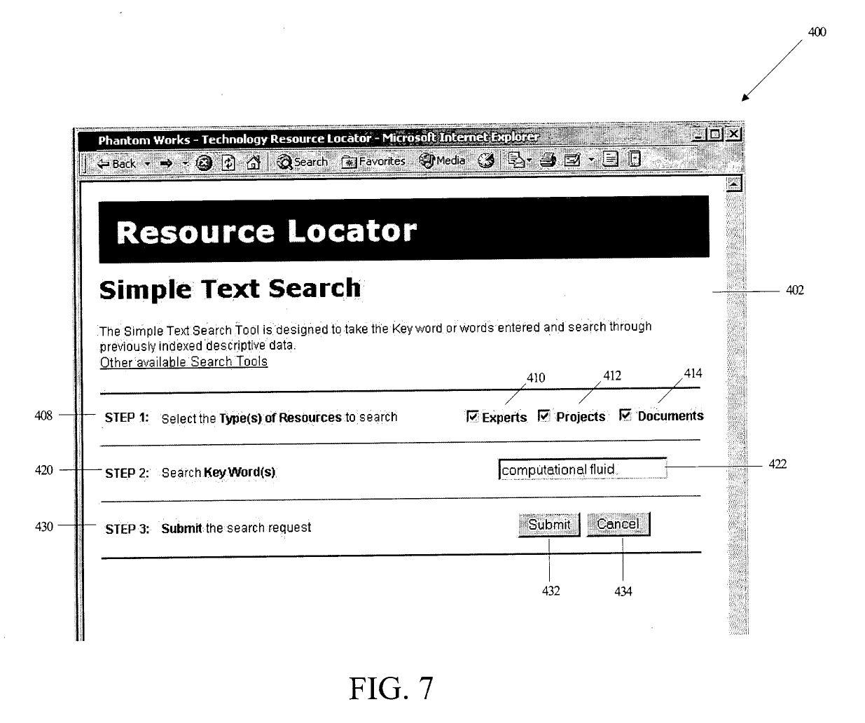

After the final export compliance information for a document has been stored, a user can retrieve the document from the database 50 and the final export compliance information for the associated document. The export compliance information informs the user about any export restrictions that apply to the document. The server 40 includes a suitable search engine that allows users to search reviewed documents stored in the database 50 or other resources, such as resumes of experts and projects. The search processes are shown in more detail below in FIG. 3 and by way of non-limiting example in FIGS. 7-9.

FIG. 2 illustrates an exemplary process 100 for performing export compliance review of electronic documents. At a block 110, through the user system 44 the user logs in to the export compliance application program that is running on the server 40. At a block 112, the user using a user interface associated with the user system 44 selects an electronic document for review. At a block 114, the user identifies if possible any recipients to whom the user intends to send the selected document. At a block 116, the export compliance application program automatically reviews the selected document with respect to the compliance rules and regulations and generates a page of concepts according to the review. The page of concepts includes words or phrases that might have particular context with respect to the rules and regulations in light of which the export compliance application program is reviewing the document. If at a decision block 118 an export compliance officer is requested to review the generated page of concepts, then at a block 122 the export compliance officer selects or deselects terms/concepts in the page of concepts according to the officer's knowledge of applicable compliance rules and any recipients if identified. If no export compliance officer review is requested of the page of concepts at the decision block 118 or the block 122 is complete, the export compliance application program automatically completes the review started at the block 116 with the selections from the block 122 and generates a hit list at a block 124. The hit list is a list of potential Export Administration Regulations (EAR) or International Traffic in Arms Regulation (ITAR) terms that provide the export compliance office with hints of where to look in the document and what terms to look for.

At a block 130, the compliance officer is informed, via email or other means, that a hit list has been generated (automatic review completed) and requires final review. At a block 132, the export compliance officer reviews and edits the hit list as necessary according to knowledge of applicable compliance rules and regulations and any identified possible recipients. At a block 134, the export compliance application program automatically generates final compliance information. At a block 140, the selected document and the associated final compliance information are stored in the database 50 or other such database.

Once the final compliance information has been completed for a document, the document and information are made accessible to users either through a search engine associated with the server 40 or with another server coupled to the network 48 and the database 50 or by directly informing the user that the document in which they submitted has completed export compliance review.

FIG. 3 illustrates an exemplary process 200 for performing searches of resources that have been classified and reviewed to determine access rights. The resources include but are not limited to documents that have gone through export compliance review, resumes of experts/employees, and projects. At a block 210, a user logs in to a search engine application program running on the server 40. Upon logging in to the search engine application program, user identification information is stored for use by the search engine. At a block 212, the logged in user selects the type of resources in which they desire searching.

At a block 216, the user enters keyword(s). At a block 224, the search engine application program automatically searches the stored resources for hits based on the entered keyword(s), the selected resource types, and the information associated with the requester/user. This is illustrated in more detail below by example in FIGS. 7-9. The search engine application program incorporates a classifier application program such as that taught in the U.S. patent application titled Knowledge Management Using Text Classification, Ser. No. 10/095,673, which is hereby incorporated by reference.

Information stored in many different formats types, such as without limitation all word processing formats, Adobe®, and any SQL compliant database, is usable by the classifier application program of the present invention. The classifier application program determines content of information streams based on one of a number of different thesauruses, security rules, such as that described above, or other knowledge bases. The classifier application program thereby allows for an effective knowledge management system.

FIG. 4 illustrates a window 300 that includes a user interface page 306 that is provided to a user system 44 by the export compliance application program running on the server 40. The page 306 includes a document upload area 310 that allows a user to select an electronic document that has been run through export compliance review. The area 310 includes a display window 320, and a browse button 322. The user can directly enter the location (directory location) of the document in the window 320 or the user retrieves documents by use of the browse button 322 that accesses the hard drives (memory) accessible from the user's system 44. Once the user has selected a desired document and it is shown properly in the window 320, the user selects an upload button 324 which sends the document to the export compliance application program for review.

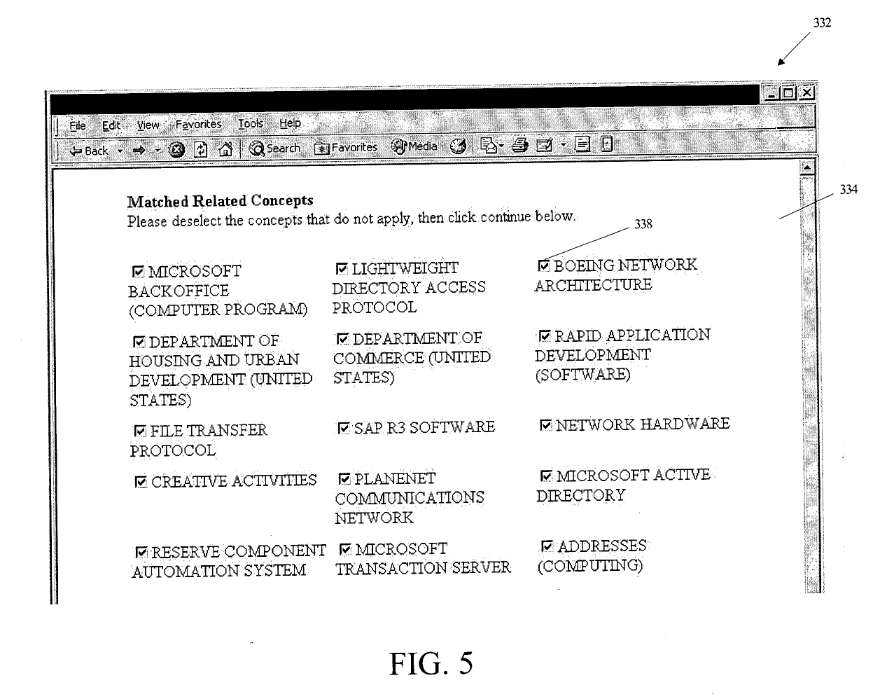

FIG. 5 illustrates a window 332 that presents a concepts page 334, as described at block 116 of FIG. 2. The page 334 presents a scrollable list of terms or concepts that the export compliance application program discovered in the selected and uploaded document that might present some issues with respect to compliance rules and regulations. In one embodiment of the present invention, a check box 338 is displayed adjacent each of the identified terms or concepts. The check boxes 338 are initially checked and in one embodiment can only be unchecked by someone of proper authority, suitably an export compliance officer.

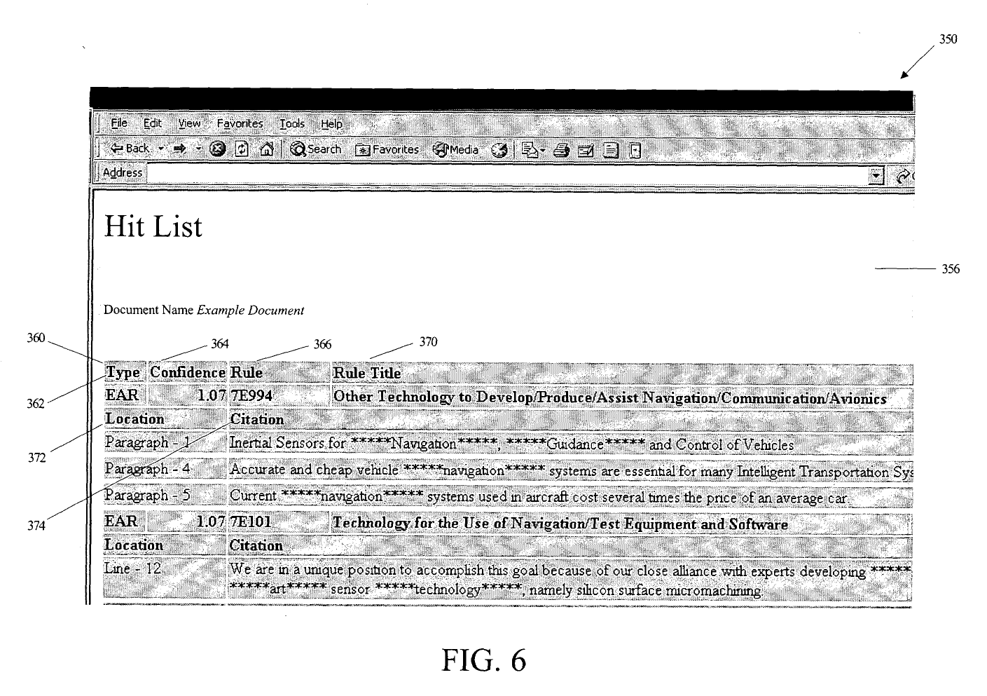

FIG. 6 illustrates a window 350 that presents an example hit list that relates to a document that has been reviewed by the export compliance application program. The hit list 356 includes a hit list table 360. The hit list table 360 includes any hits/conflicts that the export compliance application program has found between the reviewed document and the applicable compliance rules and regulations based on the checked concepts from the concept page 334. Each hit in the hit list table 360 suitably includes a type section 362, a confidence section 364, a rule number section 366, a rule title section 370, a location section 372, and a citation section 374 that is associated with the location. The value in the confidence section 364 is a rating that indicates to the export compliance office the exactness of the match between the term and its use within the document as applies to a potential EAR or ITAR issue. The citation section 374 includes a sentence or a portion of a sentence that includes the word(s) that apply to the rule identified in the rule number section 366. The location section 372 identifies the location in the document for the citation from the citation section 374. The type section 362 identifies the regulation, such as EAR or ITAR, that is associated with the conflict.

FIG. 7 illustrates an exemplary search window 400 that includes a search user interface page 402. The search user interface page 402 includes sections 408, 420, and 430 that present the steps in which to perform, in one embodiment, a text search of the resources in the database 50. In the section 408, the user selects the type of resource in which to perform the search. In this embodiment, the resources include experts 410, projects 412, and documents 414. In the section 420, the user enters the keyword(s) into a text entry window 422. At the section 430, the user begins the search by selection of a submit button 432 or cancels the search by selecting a cancel button 434. Upon selection of the submit button 432, the keyword(s) entered into the window 422 are sent to the search engine application program on the server 40. The search engine application program searches the database 50 using the entered keyword(s).

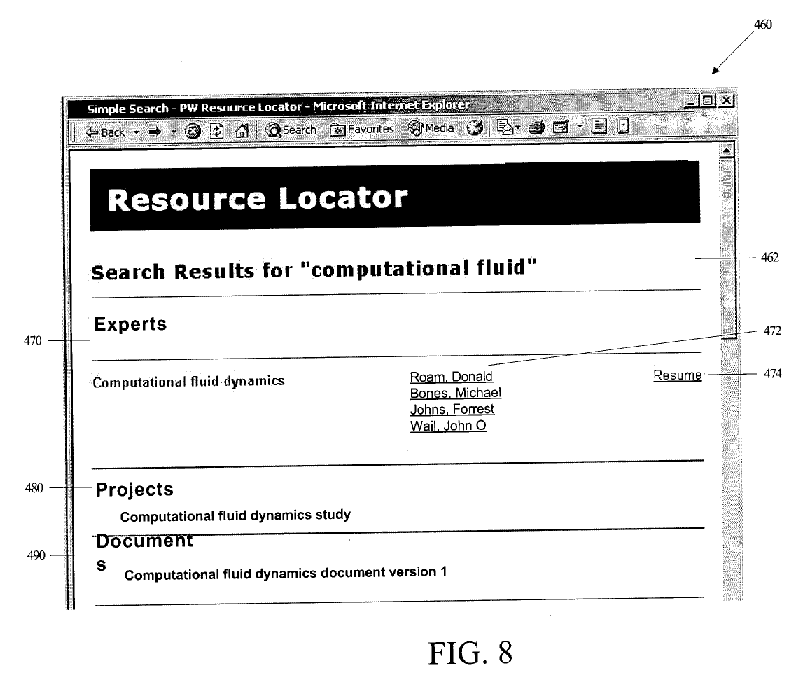

Referring now to FIG. 8, an example result produced by the search engine application program is illustrated in a search result window 460. The result window 460 includes a result page 462 that presents search results. The page 462 includes an experts section 470 that displays hyperlink names of human resources in a first column 472 and a hyperlink to the human resource's resume, if one exists, in a second column 474. A projects area 480 presents any projects past or present that are associated with the search terms. The page 462 also includes a document section 490 that presents the name and location of documents associated with the entered search terms. The documents presented in the documents area 490 are documents, which have gone through the export compliance review process shown in FIG. 2. The presented experts, projects, and documents are presented to the user not strictly based on the search term but also on the access capabilities applied to the information associated with user.

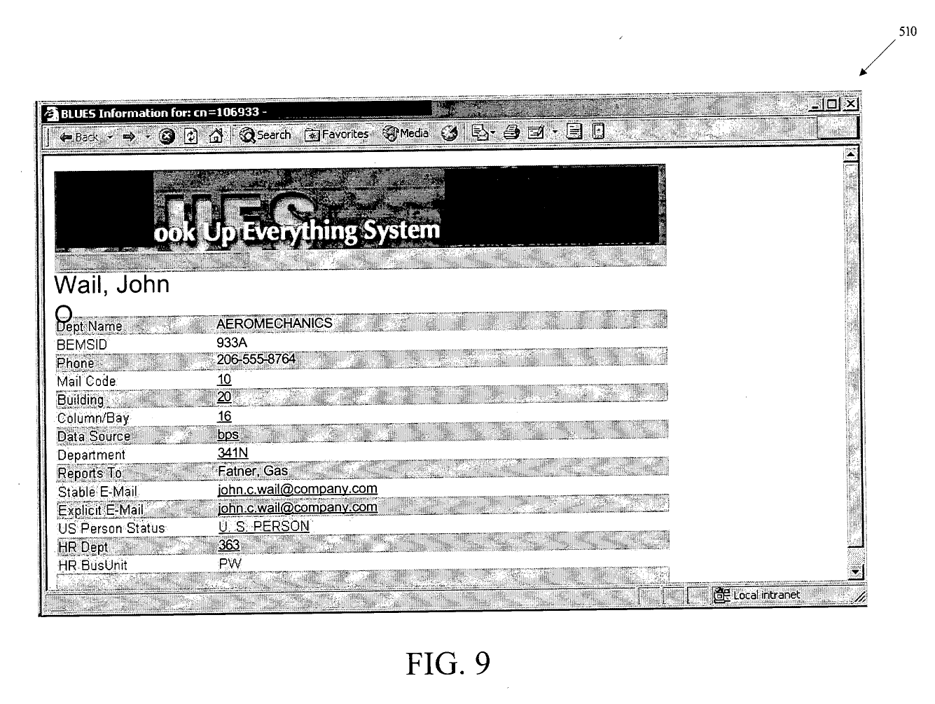

FIG. 9 illustrates an expert window 510 that presents information about an expert upon selection of an associated hyperlink shown in the expert name column 472 and experts area 470 from the search results page 462.

ITAR rules state that no foreign national can have access without prior briefing and debriefing by a security officer and without an established need-to-know. The ITAR rules are suitably retrieved from government web sites.

EAR rules indicate that once a document is tagged as having export controlled information according to the rules, the access to that document by foreign nationals is conditional as to the EAR category vs. the country the foreign national represents. EAR rules are suitably retrieved from government web sites with the main data defining the rules in Alphabetical Index to the Commerce Control List, Numerical Index to the Commerce Control List and Part 774—The Commerce Control List with the documents detailing Categories 0 through 9. EAR Part 738—Commerce Control List Overview and the Country Chart and Part 738Spir—Supplement No. 1 to Part 738, Commerce Country Chart define the relationship between the determination of information as export controlled under one of the Categories and the countries that are restricted from having access to that information. The data from ITAR and EAR documents is used to construct the knowledge base that is used in determining what terms could be considered an ITAR or EAR issue.

In one embodiment, the ITAR and EAR rules are used to define entries for a “thesaurus-like” structure along with interrelations between terms that are specified in the rules. In another embodiment, sample documents that are representative of information that would be associated with the various rules are used to “train” the server 40.

The following are examples of how the system is used with respect to the various rules. If the data identified in a document is ITAR, it is determined if the recipient is a US Person. If not, they do not have access. For EAR, if the individual is not a US Person, then the system identifies the country they represent. US Citizens can be considered as non US Persons. For example, a military officer serving with NATO is considered a Foreign National. With the Category Code that the export officer attached to the document, the individual's profile is matched with the map of export codes to countries in Part 738, Commerce Country Chart to determine if that individual may have access.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

What is claimed is:

1. A computer-based method for performing export compliance review of electronic documents, the method comprising:
submitting an electronic document for export compliance review;
automatically reviewing the submitted document according to predefined export compliance rules; and
automatically generating export compliance information based on the review.

2. The method of claim 1, further comprising:
generating final export compliance information for the submitted document based on an export compliance officer's review of the automatically generated export compliance information with respect to the export compliance rules.

3. The method of claim 2, further comprising storing the submitted document and the associated final export compliance information.

4. The method of claim 1, wherein automatically reviewing includes determining conflicts between at least one of terms or phrases from text of the submitted document and the export compliance rules.

5. The method of claim 4, wherein determining conflicts including determining thesaurus conflicts.

6. The method of claim 4, wherein the generated export compliance information identifies the terms or phrases from the text of the document determined to have a conflict with the export compliance rules based on the review.

7. The method of claim 6, wherein the identified terms or phrases include at least one of the rule number or title of the conflicting rule.

8. The method of claim 1, wherein the export compliance rules include at least a portion of Export Administration Regulations and International Traffic in Arms Regulations.

9. A system for performing export compliance review of electronic documents, the system comprising:
at least a first user system coupled to a network, the at least first user system including:
a first processor;
a user interface coupled to a processor for allowing a user to interact with information sent to and received from the network; and
memory coupled to the processor for storing electronic documents; and
a server coupled to the network, the server including:
a memory; and
a second processor coupled to the memory, the processor including:
a first component for allowing a user on the at least first user system to submit a document stored in the memory to the server;
a second component for automatically reviewing the submitted document in accordance to predefined export compliance rules; and
a third component for automatically generating export compliance information based on the review.

10. The system of claim 9, wherein the second processor further includes:
a fourth component for generating final export compliance information for the submitted document based on an export compliance officer's review of the automatically generated export compliance information with respect to the export compliance rules.

11. The system of claim 10, wherein the second processor stores the submitted document and the associated final export compliance information in the memory associated with the server.

12. The system of claim 9, wherein the second component is further configured to determine conflicts between at least one of terms or phrases from text of the submitted document and the export compliance rules.

13. The system of claim 12, wherein the second component determines conflicts based on a thesaurus database.

14. The system of claim 12, wherein the generated export compliance information identifies the terms or phrases from the text of the document determined to have a conflict with the export compliance rules based on the review.

15. The system of claim 14, wherein the identified terms or phrases include at least one of the rule number or title of the conflicting rule.

16. The system of claim 9, wherein the export compliance rules include at least a portion of Export Administration Regulations and International Traffic in Arms Regulations.

17. A computer-based method for performing export compliance review of electronic documents, the method comprising:
submitting a plurality of electronic documents for export compliance review;
automatically reviewing the submitted document according to predefined export compliance rules;
automatically generating export compliance information based on the review;
submitting a plurality of electronic resumes and reports;
processing the submitted plurality of electronic documents, electronic resumes and reports for searching capabilities;
retrieving information of a user;
entering a search request; and
searching the processed plurality of electronic documents, electronic resumes and reports based on the entered search request and the retrieved user information.

18. The method of claim 17, further comprising:
generating final export compliance information for the submitted document based on an export compliance officer's review of the automatically generated export compliance information with respect to the export compliance rules.

19. The method of claim 18, further comprising storing the submitted document and the associated final export compliance information.

20. The method of claim 17, wherein automatically reviewing includes determining conflicts between at least one of terms or phrases from text of the submitted document and the export compliance rules.

21. The method of claim 17, wherein the generated export compliance information identifies the terms or phrases from the text of the document determined to have a conflict with the export compliance rules based on the review.

22. The method of claim 21, wherein the identified terms or phrases include at least one of the rule number or title of the conflicting rule.

23. A computer-based method for performing rule based searching of previously stored electronic documents, resumes, and reports, the method comprising:
processing the submitted plurality of electronic documents, electronic resumes and reports for searching capabilities;
retrieving information of a user;
entering a search request by the user;
searching the processed plurality of electronic documents, electronic resumes and reports based on the entered search request and the retrieved user information; and
presenting the results of the search.

24. A document management system for performing rule based searching of previously stored electronic documents, resumes, and reports, the system comprising:
a display device; and
a processor including:
a first component for processing the submitted plurality of electronic documents, electronic resumes and reports for searching capabilities;
a second component for retrieving information of a user;
a third component for receiving a search request by the user; and
a fourth component for searching the processed plurality of electronic documents, electronic resumes and reports based on the entered search request and the retrieved user information,
wherein the display device presents the result of the search.

25. A computer-based method for determining content of information stored in at least one of previously stored electronic documents, resumes, reports, or databases, the method comprising:
determining content of information stored one or more of the electronic documents, resumes, reports, or databases based on a predefined criteria; and
presenting the determined content.

26. A document management system for determining content of information stored in at least one of previously stored electronic documents, resumes, reports, or databases, the system, comprising:
determining content of information stored in the one or more of the electronic documents, resumes, reports, or databases based on a predefined criteria; and
presenting the determined content.
